(19) United States
(12) Patent Application Publication
(10) Pub. No.: US 2007/0143339 A1
(43) Pub. Date: Jun. 21, 2007

(54) ARCHITECTURE FOR A SMART ENTERPRISE FRAMEWORK AND METHODS THEREOF

(76) Inventor: John C. Springett, Sacramento, CA (US)

Correspondence Address: IPSG, P.C., P.O. BOX 700640, SAN JOSE, CA, 95170-0640, US

(21) Appl. No.: 11/613,847

(22) Filed: Dec. 20, 2006

Related U.S. Application Data
(60) Provisional application No. 60/752,629, filed on Dec. 20, 2005.

(51) Int. Cl. G06F 7/00

(52) U.S. Cl. 707/103 R

(57) ABSTRACT

A system for enabling a user to execute an application on a client device is disclosed. The system includes a first datastore for storing metadata pertaining to design, development, deployment, presentation, and/or execution of the application. The design, development, deployment, presentation, and/or execution of the application may pertain to user interface and/or business logic of the application. The system also includes a second datastore storing application data pertaining to utilization of the application. The system further includes a third datastore residing in the client device for storing replicated metadata and replicated application data. The replicated metadata are a copy of the metadata, and the replicated application data are a copy of the application data. The system further includes logic residing in the client device for converting at least the replicated metadata into the at least one of user interface and business logic of the application.

### PRIORITY CLAIM

This application is related to and claims priority under 35 U.S.C. §119(e) to a commonly assigned provisional patent application entitled “Architecture For a Smart Enterprise Framework and Methods Therefor,” by John C. Springett, Attorney Docket Number STGI-POOP, Application Ser. No. 60/752,629 filed on Dec. 20, 2005, which is incorporated herein by reference.

### BACKGROUND OF THE INVENTION

Lacking good alternatives, organizations often build proprietary software applications in order to manage increasing volumes of digital information. However, the proliferation of multiple incompatible data formats, stored on different database systems, and accessed across distributed networks, has made the application development process overly complex, and hence extremely costly. Because of substantial time pressure, or a lack of technical design experience, many applications are often quickly designed and poorly implemented. Consequently, the development costs often exceed the software and hardware costs by an order of magnitude or more. In addition, complex systems often require sophisticated, substantial, and costly perpetual support.

Enterprise applications with two or more components that are connected over a network are often referred to as n-tier architectures, where n is an integer greater than or equal to two. For example, a web browser and a web server. If a database is relatively simple, and the majority of client access is local (as opposed to geographically distributed), a client application may be all that is required for database access. That is, a two-tier implementation, in which a custom fat or thick client is created (in a client layer) in order to retrieve and update information that is stored in a database (in a database layer). Thick client generally refers to an additional and/or relatively large (e.g., >1 MB) application, not commonly included with the operating system, but may provide a graphical user interface in order to access the database, as well as business logic in order to simplify and optimize user data interaction.

In general, traditional databases are organized by fields, records, and tables. A field is a single piece of information; a record is one complete set of fields; and a table is a collection of records. For example, a telephone book is analogous to a table. It contains a list of records, each of which consists of three fields: name, address, and telephone number. Tables, in turn, are organized into schema. A schema is commonly a conceptual model of the structure of a database that defines the data contents and relationships. A database definition language specification is an implementation of a particular schema. In general, the database schema must be properly designed, or the overall application will not function correctly. In addition, database applications also generally include a collection of programs that enables the modification and extraction of information from a database, called a DBMS (database management system).

Referring not to FIG. 1, a simplified diagram of a two-tier implementation architecture is shown. The diagram can be divided into a data layer 102 and a client layer 106. Data layer 102 typically comprises elements that are primarily focused on accumulating, processing, and transforming data, such as database 108. For example, a small office may maintain customer records in an Oracle database. Client layer 106 typically comprises elements that are primarily focused on both providing business logic and rendering the processed data for a user, such as thick client 110. For example, the small office may have created a proprietary thick client (e.g., MS Access, Visual Basic, Visual C++, etc.) that is locally installed on each user's computer. In addition, thick client 110 generally interfaces with database 108 through a query language such as SQL (structured query language), a standardized query language for requesting information from a database.

Thick client 110 may be further developed with IDE (integrated development environment) 112, (e.g., Microsoft Visual Studio, Eclipse, etc.). In general, an IDE is a GUI workbench for developing code, featuring facilities like symbolic debugging, version control, and data-structure browsing. In addition, SQL editor may be used for prototyping and creating views (subsets) of the data in database 108. In general, a SQL editor 114 display the text being edited on the screen as it is being edited. In general, the more complex the view, the more prone it may be to being displayed improperly at thick client 110.

However, the two-tier implementations are not optimized for scaling beyond just a few clients. For example, the application logic (e.g., the rules of how the application should run) is generally divided between a centrally located database and a distributed set of clients. Consequently, updating and/or maintaining software often requires physically modifying each client device, which is time consuming. In addition, since the queries are generated by the client, the database access may not be optimized, creating additional network traffic and decreasing application performance. Furthermore, security may also be problematic, since database access is controlled at each client. If the client is compromised, the database may also be compromised.

In contrast, decentralized enterprise applications are generally configured with at least three components connected over network, in which either a thick client or a thin client (e.g., browser, etc.) in a client layer, may be coupled to one or more application servers in an application layer, that in turn, may be coupled to one or more databases in a data layer. An application server, or appserver, is generally a centralized software application that generally shares processing burden with client and performs the business logic necessary to provide clients with access to the databases. In web environments, an application server generally sits beside a web server or between a web server and enterprise information systems. A thin client generally refers to an application that is commonly included with the operating system, such as a browser, or an installed application that is relatively small (e.g., <1 MB) that must be installed to access the database.

Consequently, updating and/or maintaining software is substantially easier than the two-tier implementation because much of the software (e.g., application logic and database logic) is generally centrally maintained at a data center, and not distributed throughout the organization. In addition, the application server also may minimize the client data processing load, and hence improve the overall performance of the application.

Furthermore, since the client does not directly access the database, but rather interacts with the database through the application server, which itself may be protected, security may be enhanced.

Referring not to FIG. 2, a simplified diagram of a three-tier implementation is shown. The diagram can be divided into a data layer 102, an application layer 104, and a client layer 106. As previously described, data layer 102 typically comprises elements that are primarily focused on accumulating, processing, and transforming data, such as a database 108. For example, a medium size manufacturing organization may have customer information in database 108. Application layer 104 includes the application server 122, such as the order entry application server. Client layer 106 includes the clients that are used to access application, such a thick client 110 and thin client 111. In addition, IDE 112 (e.g., Microsoft Visual Studio, Eclipse, etc.) may be used to thick client 110, thin client 111, and application server 122. In the case of a thin client 111, such as a browser, IDE 112 may be used to create an installable component (e.g., java applet, ActiveX, Flash, etc.). In addition, a visual editing tool such as SQL visual editor may be used for prototyping and creating views of the data in database 108.

However, although three-tier enterprise software implementations may be scalable and reliable, they also tend to be difficult to design and time consuming to develop. For example, a major reason for redesigning the database schema is a poor understanding of the problem, and hence an incomplete model of the solution. In general, customer needs are used to create a model of the problem (e.g., order entry system, reservation system, client record system, etc.). From this model, detailed application specifications are derived to develop, among other things, a sound database structure. However, since correcting a problem in one area (e.g., schema, etc.) may in turn affect other areas (e.g., application logic, user interface, etc.), the revision process may be substantially time consuming, often taking weeks or months for large processes.

In addition, in most n-tier implementations, the client is not generally designed to be decoupled from the application server or the database. However, for performance reasons, it may be advantageous to decouple the client from the database, locally caching the data itself For example, the client application may not have a readily available network connection, or perhaps network performance has degraded. However, in many applications, such as in browser environment, if the connection is broken to the web server or the application server, an error generally occurs potentially causing a data loss.

In view of the foregoing, there is desired architecture for a smart enterprise framework and methods therefore.

### SUMMARY OF THE INVENTION

One or more embodiments of the present invention relate to a system for enabling a user to execute an application on a client device is disclosed. The system may include a first datastore for storing metadata pertaining to design, development, deployment, presentation, and/or execution of the application. The design, development, deployment, presentation, and/or execution of the application may pertain to user interface and/or business logic of the application. The system may also include a second datastore storing application data pertaining to utilization of the application. The system may further include a third datastore residing in the client device for storing replicated metadata and replicated application data. The replicated metadata are a copy of the metadata, and the replicated application data are a copy of the application data. The system may further include logic residing in the client device for converting at least the replicated metadata into the at least one of user interface and business logic of the application.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a simplified functional diagram of a two-tier implementation architecture.

FIG. 2 illustrates a simplified diagram of a three-tier implementation.

FIG. 3 illustrates a simplified diagram of a smart enterprise framework (SEF) architecture, a client-server system according to one or more embodiments of the invention.

FIG. 4 illustrates a simplified diagram of a SEF system (a client-server system), according to one or more embodiments of the invention.

FIG. 5 illustrates a simplified diagram showing a process of creating or updating an enterprise application with the SEF system, according to one or more embodiments of the invention.

FIG. 6 illustrates a simplified diagram of a SEF system deployment, according to one or more embodiments of the invention;

FIG. 7 illustrates a simplified diagram of a SEF authentication process, according to one or more embodiments of the invention.

FIG. 8 illustrates a simplified diagram of a SEF authentication process, according to one or more embodiments of the present invention.

FIG. 9 illustrates a simplified block diagram of a deployed SEF system (a client-server system) according to one or more embodiments of the invention.

FIGS. 10A-D illustrate example user interfaces and associated metadata according to one or more embodiments of the invention.

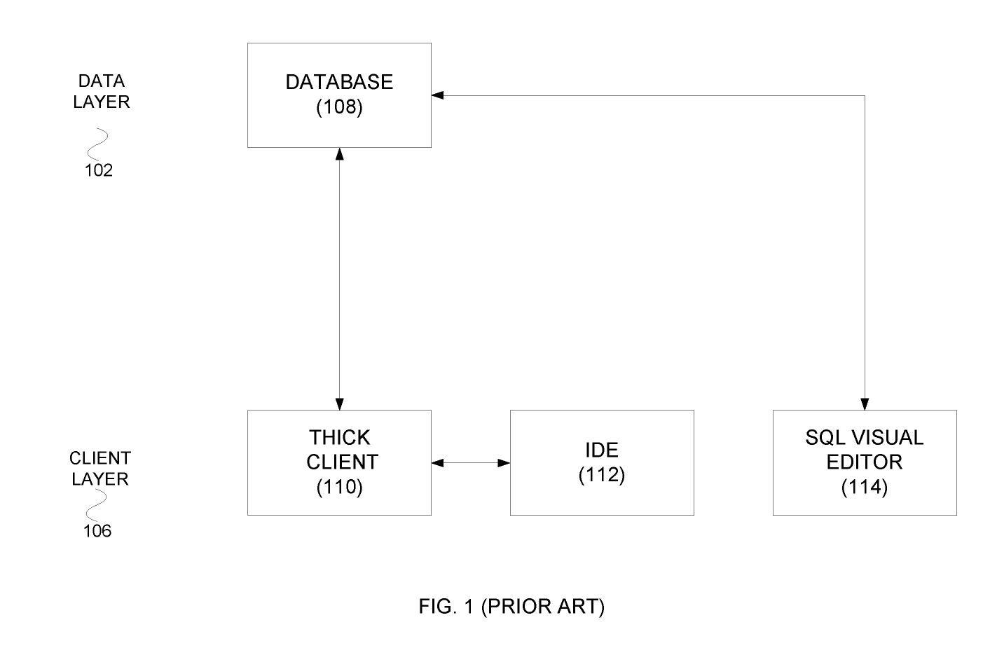

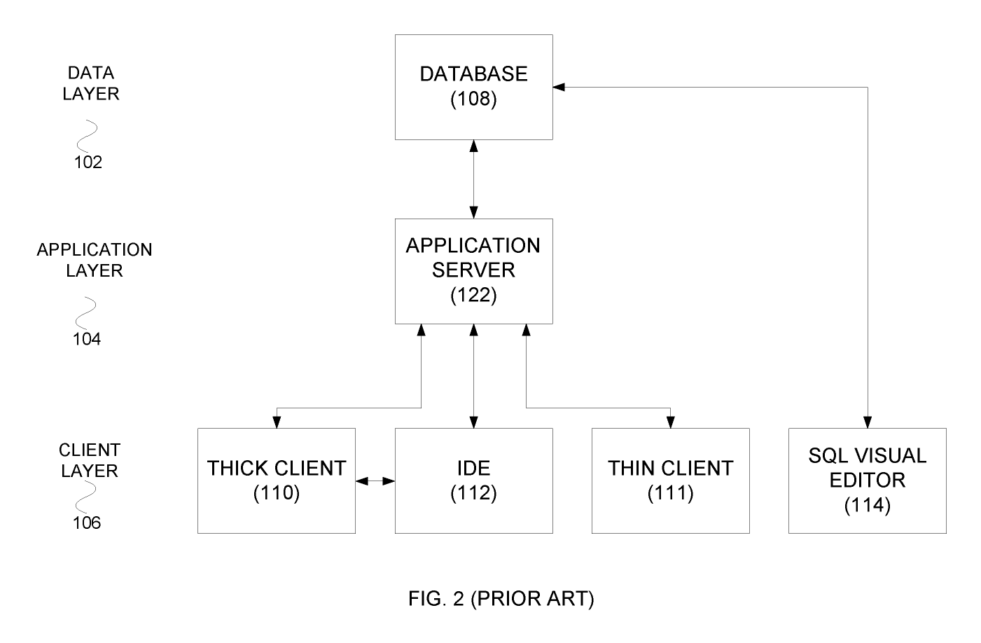

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

One or more embodiments of the present invention relate to a system for enabling a user to execute an application on a client device. The system may include a first database configured to store metadata pertaining to design, development, deployment, presentation, and/or execution of the application. The design, development, deployment, presentation, and/or execution of the application may pertain to user interface and/or business logic of the application. The system may also include a second database configured to store application data pertaining to utilization of the application. The system may further include a third database (or a third datastore) residing in the client device and configured to store replicated metadata and replicated application data. The replicated metadata may be a copy of the metadata, and the replicated application data may be a copy of the application data. The system may further include logic residing in the client device and configured to convert at least the replicated metadata into the at least one of user interface and business logic of the application.

One or more embodiments of the present invention relate to a method for deploying an application on a client device used by a user. The method may include creating a first database for storing metadata pertaining to at least one of design, development, deployment, presentation, and execution of the application. The at least one of design, development, deployment, presentation, and execution of the application may pertain to at least one of user interface and business logic of the application. The method may also include creating a second database for storing application data pertaining to utilization of the application. The method may further include creating a third database in the client device for to storing replicated metadata and replicated application data. The replicated metadata may be a copy of the metadata, and the replicated application data may be a copy of the application data. The method may further include implementing logic in the client device for converting at least the replicated metadata into the at least one of user interface and business logic of the application.

One or more embodiments of the present invention relate to a method for updating an application on a client device used by a user. The method may include connecting the client device to a first database. The first database may store metadata pertaining to at least one of design, development, deployment, presentation, and execution of the application. The at least one of design, development, deployment, presentation, and execution of the application may pertain to at least one of user interface and business logic of the application. The method may further include replicating the metadata to produce replicated metadata. The method may further include converting at least the replicated metadata into the at least one of user interface and business logic of the application.

In accordance with one or more embodiments of the present invention, a Smart Enterprise FrameworkTm (SEF), a client-server system, is advantageously employed to rapidly create a decentralized n-tier enterprise application. In general, SEF may include a set of smart clients (e.g., development clients, runtime clients, etc.) and optimized metadata constructs that may be used by a business analyst to rapidly design, develop, and deploy decentralized data applications in a substantially secure, highly available, and scalable fashion. In general, a business analyst is a person with experience that is greater than an application user, but less than an application developer. Development clients (e.g., SEF Content Designer™, SEF Report Designer™, SEF Folder Designer™ etc.) may be used to create the metadata constructs (based on customer requirements) in a SEF Master Database™ (a first datastore or a first database in a first datastore), that may in turn be used to rapidly deploy the application for access by the runtime clients. SEF Master Database™ may be a central information repository about all the deployed systems and/or applications. The SEF Master Database™ may contain all the necessary information about every deployment and every build, including relevant SEF user and security data.

In general, a smart client is a web service application that may be deployed and updated from a centralized server. Web services are typically self-describing software modules, semantically encapsulating discrete functionality, wrapped in and accessible via standard Internet communication protocols like XML and SOAP. Based on XML, a universal language of Internet data exchange, web services can communicate across platforms and operating systems, regardless of the programming language in which the applications are written. In general, each Web service is a discrete unit of code that handles a limited set of tasks. However, although web services remain independent of each other, they can loosely link themselves into a collaborating group that performs a particular task.

Designed to consume web services, a smart client may also be decoupled from the centralized server in order to run in occasional or intermittent connectivity situations, such as those used by traveling workers or even those running on laptops, tablets, PDA's, and so on, where connectivity cannot be guaranteed at all times, being able to work while disconnected is essential. In addition, the need for an application server may be reduced or even eliminated, since a smart client (unlike a traditional thin client or thick client) may be able to optimize performance and usability by caching data and managing the connection, as well as efficiently utilize local client resources (e.g., CPU, local memory or disk, locally installed software applications, etc.). A smart client may also be able to manage its deployment and updates in a much more intelligent way than traditional thin and thick client applications, further simplifying development and deployment. In addition, evidence-based code access security allows smart clients to be given limited permissions in order to restrict their functionality in semi-trusted scenarios.

As previously discussed, developing an enterprise application generally involves substantially understating the customer need or problem (e.g., order entry system, reservation system, client record system, etc.), creating a conceptual model of the problem, developing a sound database schema from that conceptual model, deploying the application including the clients if needed, and then testing the application to ensure usability, reliability, scalability, auditability, etc.

However, as with most software development, the later a problem is discovered, the harder the problem is to correct, since correcting a problem in one area (e.g., schema, etc.) may in turn affect other areas (e.g., application logic, user interface, etc.). Consequently, the revision process may be substantially time consuming, often taking weeks or months for large processes. However, in an inventive way, the SEF may accelerate the development process from weeks to hours, allowing the application to have multiple testing cycles. This is particularly useful when the conceptual model is incomplete or not completely understood by the intended application users.

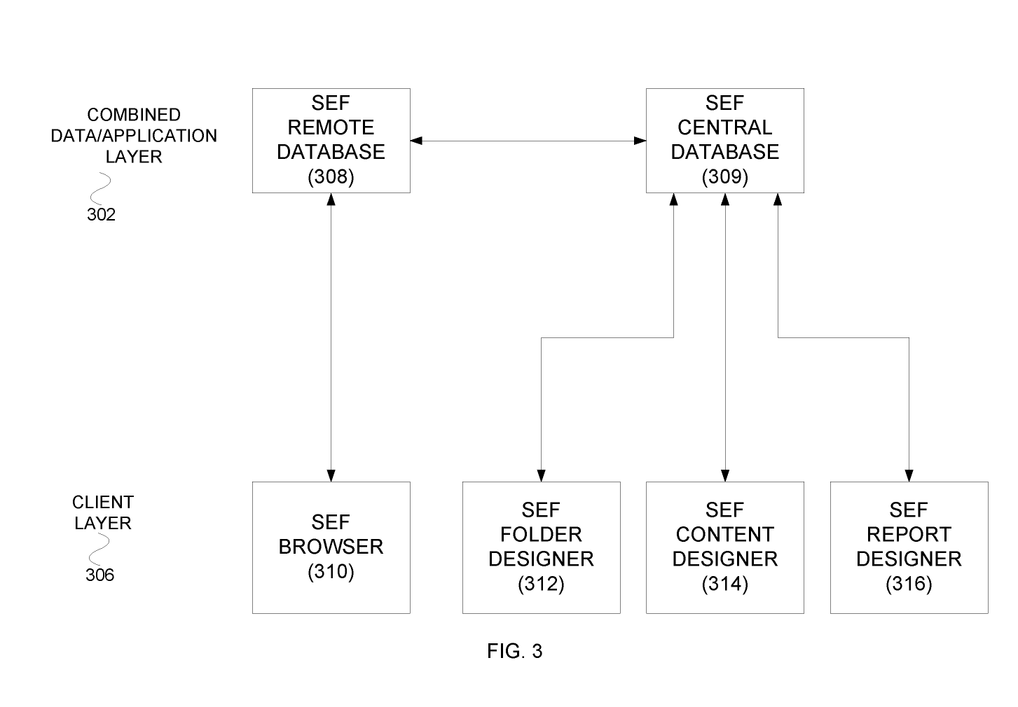

Referring now to FIG. 3, a simplified diagram of a SEF architecture (a client-server system) is shown, according to one or more embodiments of the invention. Unlike traditional n-tier implementations, an application server may not be required, allowing the data and application layers to be combined, and thus reducing overall application latency. The diagram can be divided into a combined data/application layer 302, and a client layer 306. In addition, in an embodiment, a SEF Browser™ 310 smart client is used to access the application.

In an embodiment, SEF Browser™ 310 may represent a run time NET Windows module to render forms created by SEF Content Designer 314, based on folders created by SEF Folder Designer 312. In general, SEF Folder Designer 312 generates the application database tables, including the data fields, while the SEF Content Designer defines the application. In addition, the SEF Browser leverages ASP.NET/Windows Forms for rendering the data.

Data transactions occur through generated business objects which use a data library that manages connections, handles data encryption and decryption, and caching of the data for improved performance. Furthermore, SEF Browser 310 is also able to display XSLT reports created by SEF Report Designer™ 316. XSLT is an extensible stylesheet language transformation (XSLT) is a language for transforming XML documents into other XML documents. XSLT is designed for use as part of XSL, which is a stylesheet language for XML.

In a configuration, SEF Browser 310 accesses SEF Remote Database™ 308, which may be coupled to SEF Central Databaser™ 309 through a network connection, such as the Internet or a LAN. SEF Central Database Server 309 is generally the central repository of the actual application data. There is usually a single SEF Central Database per deployment. SEF Remote Database™ 308 may be utilized when SEF Browser 310 is decoupled from SEF Central Database Server 309.

Data Encryption keys are built as one set of cryptographic keys per SEF system configuration. Each system commonly has an encrypted metadata database, business data database and archive database. All databases may be based on SQL 2005 Enterprise engine. In general, the same cryptographic data keys are used for all three databases, but different types of encryptions are applied to metadata (simple encryption) and to business (highly secure encryption) databases.

In order to support both online and offline remote working modes, clients may be configured with system metadata and business databases data (excluding retired records) replicated down to client (e.g., laptop, Tablet PC, etc.) using pull replication the first time after client installs SEF assemblies and periodically thereafter (e.g., every 14 days after last successful replication, etc.). In general, if replication attempt has failed, SEF application may be locked. SEF application may also be locked down if the license has expired or is not valid.

Remote client assemblies may be updated as soon as new updates are published. In general, an update happens proactively without a user's explicit request for. In addition, CAS (code access security principal) may be applied to deployed signed assemblies. ClickOnce deployment may control distribution of prerequisites on client machines (e.g., NET framework 2.0, SQL Express, FarPoint 1.09 Windows Spread, etc.), installs the correct version if needed, and reboots a machine afterwards if necessary. ClickOnce deployment also generally gives control over granulated limited assemblies' access configuration to different resources on client machines and on intranet zone.

In addition, an offline database snapshot may be created on another server for reporting purposes. The database snapshot would be created daily and an unencrypted version of each table of such snapshot will be displayed in a corresponding view.

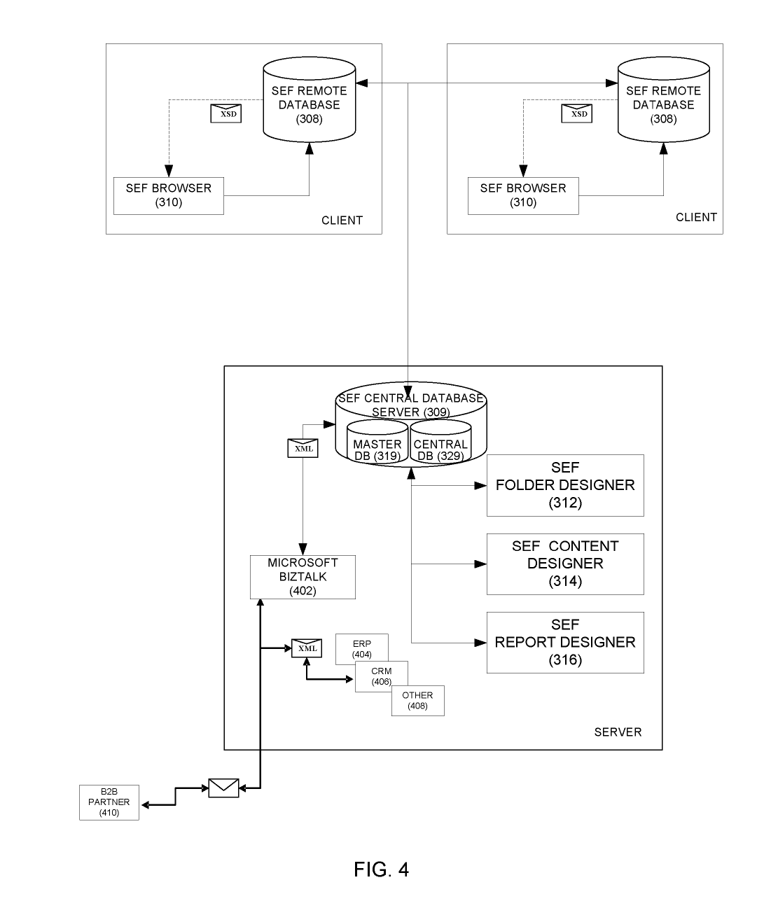

Referring now to FIG. 4, a simplified diagram of typical SEF deployment, according to one or more embodiments of the invention. In general, a SEF Central Database Server 309 maintains a SEF Master Database 319 (a first database or a second datastore) as well as at least one SEF Central Database 329 (a second database or a second datastore) for each client application. SEF Master Database 319 may generally store metadata, or information about how systems and/or applications have been or are to be presented, executed, designed, developed, and/or deployed with the SEF (“deployed systems”). For example, the metadata may include data that describe user experience, authorization rules, etc. The metadata may be interpreted by logic residing in a client device and may be converted (or constructed) into viewable and/or updatable user entry controls. Likewise, SEF Central Database 329 is generally the central repository of the actual application/business/user data pertaining to utilization of the application. The application data also may be interpreted and converted by the logic in the client device to be useable by a user. There is usually a single SEF Central Database per application deployment.

SEF Content Designer 314 renders forms based on folders created by SEF Folder Designer 312, and stored in a particular SEF Central Database™ (e.g., SEF Central Database 329), along with generated reports created with SEF Report Designer 316. In order to allow a remote user to work offline, as well as improve overall performance by caching application data near the appropriate SEF Browser 3 10, each SEF Central Database™ may replicate with a SEF Remote Database™ (e.g., SEF Remote Database 308, a third database). For example, if the SEF Browser is installed on a PC, a copy of the SEF Remote Database may also be installed. SEF Central Database 329 may be replicated to SEF Remote Database 308 whenever the remote computer (the PC) becomes online (e.g., connected with SEF Central Database Server 309). Each SEF Remote Database 308 also may be replicated to the SEF Central Database Server 309 whenever the remote computer becomes online. For example, if the remote computer is attached to a wireless network, if that connection is disrupted, a user through SEF Browser 310 may still access the latest replicated version of the data in the SEF Central Database 309.

In general, a SEF Remote Database 308 communicates with SEF Browser 310 by XSD messages. XSD (XML Schema Definition) is an instance of an XML schema written in the XML Schema language. An XSD defines a type of XML document in terms of constraints upon what elements and attributes may appear, their relationship to each other, what types of data may be in them, and other things. It can be used with validation software in order to ascertain whether a particular XML document is of that type, and to produce a Post-Schema Validation Infoset. SEF Browser 310 may, itself, be secured through standard authentication mechanisms (e.g., smart card, PIN, biometric scan, etc.).

In addition, SEF Central Database Server 309 may itself be coupled to other applications within the same organization, or to applications in other organizations through an interface tool such as through a Microsoft Biz Talk application. BizTalk is an industry initiative started by Microsoft and supported by a wide range of organizations like SAP, CommerceOne and Ariba. This initiative is establishing a set of guidelines for how to publish schemas in XML and how to use XML messages to easily integrate software programs together in order to build rich new solutions.

Subsequently, enterprise application developed with SEF may have substantial advantages. For example, the system may be 100% fail over safe and available at all time, both on and off line. In addition to data encryption, web based security such as HTTPS, and Biometrics Access Control using Smart Card Technology, the security is further enforced by defining a network of system independent users and roles, and imposing vertical and horizontal data access control and filtering. Complying with the underlying widely used OS, database, process management, and other system level requirements and architecture, SEF can easily be farmed and clustered to scale. SEF emphasizes a highly productive environment for RADD (Rapid Application Development and Deployment) allowing for business objects to be reused.

In addition, SEF has friendly and freshly designed tools to trace, monitor, deploy and debug. Written on top of widely used and well known software products such as SQL Server 2005, BizTalk (e.g., BizTalk 2006), IIS, and SharePoint Portal Server, the system may comply to SQL, XML, HTTP and other standards for quick and easy interoperability as well as availability. The system may utilize BizTalk 2006 for native unparallel support for Business Intelligence. The system is fully aware of high performance features of SQL Server for replication, or IIS for load balancing, or BTS for process deployment and further allows for fine tuning such services for C2R Replication (Central to Remote), R2C Replication (Remote to Central), and SEF2SEF. SEF records and maintains every transaction, and every change made to any record and is capable or reproducing any version of any record.

A. Development Clients

SEF development clients are generally responsible for creating and populating database tables, creating stored procedures, triggers, data management objects, user interfaces and reports. Additionally, the development clients may create scripts to load responsible applications in the appropriate directories as well as set up the correct runtime environment (PATH variable, etc.).

In an embodiment, at least three development clients are used to develop and deploy a decentralized enterprise application: a SEF Content Designer, SEF Folder Designer, and a SEF Report Designer. For example, in a typical “Design” scenario, after detailed analysis of a system's requirements, a field expert (e.g. Business Analyst) with minimal knowledge of SEF may be able to use the SEF Content Designer and a SEF Folder Designer to design a custom system. A customized system is may be generated from a complex collection of metadata. These tools generate and configure the application/s as well as all the necessary objects, including databases and their relevant tables, ready to launch. The generated system, by design, generally lacks any security features which are expected to be added by the client as the final step.

The final step, defined and configured by the customer, is to detail the authorization and authentication security requirements for different users and roles.

Once the system is deployed, additional changes, from data model modifications to changes in the actual code, are then pushed to the client systems through SEF's powerful publish and subscribe model.

1) SEF Content Designer

As previously explained, the SEF Content Designer allows a business analyst to define entities and the application GUI. SEF Content Designer is a user friendly, drag and drop, .NET smart client module that is used to define entities and the application GUI (graphical user interface). In an embodiment, SEF Content Designer utilizes SQL Server 2005 DDL to replicate the changes to production systems.

In general, entities may be saved in the seffntity metadata table, entity attributes may be saved in sefEntityAttribute metadata table, and the relationships among primary and foreign keys of entities may be saved in the sefrelationship metadata table. After all entities and their relationships are generally defined, an application may present a publishing option which would serialize design to a metadata database.

In addition, since entities and the application GUI must initially be created in the SEF Central DB, SEF Content Designer may generally only be used while connected to the SEF Central DB. Once started, the system will detect if it is connected to the SEF Central DB. If the SEF Content Designer detects a connection, it then prepares for authentication. If a connection is not present the SEF Content Designer asks for a connection from the SEF Central DB or shuts down.

Once the user enters the credentials, if the user is not an authorized “Content Designer” the application will generally close indicating the correspondent error. In an embodiment, an authenticated user will be allowed to see an environment in an SEF Browser with the following components:

Menu Bar—includes the following Menus

File—allows saving the definitions to XSD;

Edit—allows undoing last action, copy and paste.

View—common view options, toolbars, zoom, etc

Administration

User Settings

Compilation—determines if the folder definition is correct

Deployment—allows the deployment

Publishing—allows the folder to be published into the server and then started being used by all users.

Help—Data about the program

ToolBoxes

System Objects—includes all the system entity attributes that the user will be able to define in a folder

Properties—indicates the type of folder—Parent, Child, Super, etc.

Results—shows the results of compiling, deploying and publishing the folders.

Schema—contains a representation of all of the system entities and their dependencies/relationships.

Folder Dependencies—contains a list of dependencies of the primary entity for the current folder

An entity is generally a database table that contains a collective definition of customer system related artifacts and helps bridge dynamically built user interface (forms) exposed to an end user with underlying dynamically built business database/tables/fields repository structures, and with data filtered according to security permissions restrictions imposed on an end user or group of users. Entity attributes are generally fields in the entity database.

In general, an entity is a primary fundamental building block of the smart enterprise framework. In an advantageous manner, entities allow for greater flexibility in system construction than most common configurations, by defining major system components in generic fashion. An entity may be further defined via metadata, which may allow for a dynamic construction of system artifacts—both data tables and GUI forms/Tabs content.

In addition, an entity and entity attributes may also enable the near-real time data exchange among 1) business partners' legacy applications and SEF (CustomerApp) application and 2) between different Customer App locations' SEF (Customer) applications. In general, Customer-App refers to customer software (e.g., MS Word, Excel, etc.).

A. Example: User Interface Component—Tab Named Person

In a first example, in a user interface window, a tab user interface component is displayed named Youth (youth tab). Controls on the youth tab interface pane may, in turn, be linked to the business database table (entity) also named Youth (youth table).

After initially selecting the tab, a grid may be displayed with the list of youth records corresponding to entries in the youth table. In general, the pane would contain Save, Edit and Delete buttons for each youth record, as well as an Add button above the grid in order to insert a new record. When, for example, the Add or Edit buttons are selected, the grid generated by selected youth tab may be replaced by simple controls from the selected single record from youth table (e.g., a record describing Joe Young). After a record is newly entered or changed, selecting the Save button would save the record into the youth table, as well as refresh the display grid.

For example, for a record relating to Joe Young, controls on the youth tab pane may be mapped to the following youth table (entity) fields:

textbox LastName=Young

textbox FirstName=Joe

datatimepicker DOB=1/1/2000

textbox caseNo=‘11111111’

textbox MedicareNo=‘22222222’

numericcontrol CRISEENo=99990000

textbox SSID=‘122-222-3333’

B. Example: User Interface Component—Tab Named Employee

In a second example, in a user interface window, a tab user interface component is displayed named Employee (employee tab). Controls on the employee tab interface pane may, in turn, be linked to the business database table (entity) also named Employee (employee table).

After initially selecting the tab, a grid may be displayed in the employee tab pane with the list of employee records corresponding to entries in the employee table, including last and first names and addresses. In general, the pane would contain Save, Edit and Delete buttons for each employee record, as well as an Add button above the grid in order to insert a new record. When, for example, the Add or Edit buttons are selected, the grid generated by selected employee tab may be replaced by simple controls from the selected single record from employee table (e.g., a record describing Jim Hunt). After a record is newly entered or changed, selecting the Save button would save the record into the youth table, as well as refresh the display grid.

For example, for a record relating to Jim Hunt, controls on employee tab pane may be mapped to the following employee table (entity) fields:

textbox LastName=Hunt

textbox FirstName=Jim

textbox Address1=111 Veirs Mill Rd

textbox Address2=Suite 101

textbox City=Bethesda

listbox State=dropdown list of USA states with pre-selected state MD

textbox Zip=22222

C. Security Subsystem Entity: User Interface Component: Tab named Customer-App Use

In a third example, in a user interface window, a tab user interface component is displayed named Customer-App User (user tab). Controls on the user tab interface pane may, in turn, be linked to the business database table (entity) named Customer-App User (user table).

After initially selecting the tab, a grid may be displayed with the list of authorized users (e.g., entries in the table employee, including login information and keys for accessing Customer-App's data). In general, the pane would contain Save, Edit and Delete buttons for each user record, as well as an Add button above the grid in order to insert a new record. When, for example, the Add or Edit buttons are selected, the grid generated by selected user tab may be replaced by simple controls from the selected single record from user table (e.g., a record describing Lorenzo Vallone). After a record is newly entered or changed, selecting the Save button would save the record into the user table, as well as refresh the display grid.

For example, for a record relating to Lorenzo Vallone, controls on user tab pane may be mapped to the following user table (entity) fields:

textbox LastName=Vallone

textbox FirstName=Lorenzo

textbox Password=hiddenPassword

texbox Email=LorenzoVallone@frb.com

textbox MetadataKey=RTRWUIOIPLMNBCBCBCVC

textbox BusinessDataKey=2222( )(bnnmbNBhghjghgyhgj2

D. Security Subsystem Entity: AuthorizationGroup Interface component—Tab Named AuthorizationGroup

In a fourth example, in a user interface window, a tab user interface component is displayed named Customer-App AuthorizationGroup (authorization tab). Controls on the authorization tab interface pane may, in turn, be linked to the business database table (entity) named AuthorizationGroup (authorization table).

After initially selecting the tab, a grid may be displayed with the list of authorized users (e.g., entries in the authorization table which would describe groups of users and corresponding access permissions). In general, the pane would contain Save, Edit and Delete buttons for each authorization record, as well as an Add button above the grid in order to insert a new record. When, for example, the Add or Edit buttons are selected, the grid generated by selected authorization tab may be replaced by simple controls from the selected single record from authorization table (e.g., a record describing an authorization record, such as Group Administrators). After a record is newly entered or changed, selecting the Save button would save the record into the authorization table, as well as refresh the display grid.

For example, for a record relating to Group Administrators, controls on the authorization tab may be mapped to the following authorization table (entity) fields:

textbox AuthorizationGroupName=Administrators

textbox AuthorizationGroupDesc=Read, Write, Delete Access

E. Security Subsystem Entity: Userauthorizationgroup Interface Component—Tab Named Userauthorizationgroup

In a fifth example, in a user interface window, a tab user interface component is displayed named Userauthorizationgroup Interface Component (user-authorization tab). Controls on the user-authorization tab interface pane may, in turn, be linked to the business database table (entity) named UserAuthorizationGroup (user-authorization table).

After initially selecting the tab, a grid may be displayed with the list that maps users to groups, including the difference application specific access permissions. In general, the pane would contain Save, Edit and Delete buttons for each authorization record, as well as an Add button above the grid in order to insert a new record. When, for example, the Add or Edit buttons are selected, the grid generated by selected user-authorization tab may be replaced by simple controls from the selected single record from user-authorization table (e.g., a record describing an user-authorization record, such as the names of users who are members of Group Administrators). After a record is newly entered or changed, selecting the Save button would save the record into the user-authorization table, as well as refresh the display grid.

In addition, SEF Content Designer may provide a facility for editing textual design source, to facilitate the development of complex applications. In general, the format of the design source will depend on whether ASP.NET or Windows Forms is leveraged for GUI rendering. The user may be able to query each folder by fields assigned for the effect (not all the fields will be searchable).

Furthermore, SEF Content Designer may allow specific attributes (table columns) to be defined as confidential or containing sensitive information. The data in these columns will be encrypted for storage in the local DB and decrypted at run-time for presentation to authorized users. It may also generate Business Objects that will contain all of the code for database transactions.

In general, a business object contains code to perfor™ the following database transactions:

Insert

Delete (setting the deletion flag on a record AND on all of its child records)

Update (one update will update all fields)

Query (one per field elected to be searchable)

2) SEF Folder Designer

The SEF Content Designer generally allows a business analyst to define and generate the application tables that will, in turn be used by SEF Content Designer, as previously described. In general, there are no standards for separating the business/data entity design process and the GUI design process.

SEF Content Designer generally presents a hierarchy of tabs/folders as shown in the SEF Browser, and is visually and functionally presented as a Tree View. Data produced by Navigation Designer may generally be persisted to metadata database into sefUINavigation table.

In addition, SEF Folder Designer avoids complex which-came-first dependencies during GUI design. For example, in many-to-many relationships, an entity needs to be first defined to be referenced but at the same time that same entity wants to reference other entities that are not yet defined. The SEF Folder Designer is also generally able to validate GUI components' type against the entity attribute data type (i.e. Boolean, Date) or entity type (i.e. lookup or parent entity with one-to-many-relationship with primary folder entity, or an entity with a many-to-many relationship to the primary folder entity).

Furthermore, SEF Folder Designer is able to drive GUI design from entities. For example, by dragging an entity onto a folder which has a many-to-many relationship with the primary folder entity, a multi-select list box would be displayed. The SEF Content Designer could then be presented with the option of having a related entity section with add/remove capability (a complex, multi-element component), but these two component types would be the only valid options for this type of entity. In an embodiment, in order to implement full data versioning for SEF Folder Designer generated tables on the Server (Central DB) only, and using an “archiving” versioning methodology.

In addition to generating the tables, indexes and relationships based on the entity design in the SEF Folder Designer, and storing metadata related to GUI layout, there is a need to generate additional metadata. For instance, for a one-to-many relationship it is important to design and record whether or not the setting of deletion flags cascades. If this one-to-many relationship is a true parent-child relationship, then the setting of deletion flags will cascade. However, if the one-to-many relationship references a lookup/control table, then the references to the retired record will simply be set to null or a default value.

3) SEF Report Designer

As previously described, SEF Report Designer may create XSLT reports. XSLT is an extensible stylesheet language transformation (XSLT) is a language for transforming XML documents into other XML documents. XSLT is designed for use as part of XSL, which is a stylesheet language for XML.

Report Designer enables a business analyst to create printable report GUI for each simple for™ of tab/folder of the remote client application front end. For example, content would include simple data bound and none-bound controls such as text box, list/combo boxes, lookup buttons, labels, images, check boxes. Data produced by UI Browser Designer are to be persisted into sefUIControl, sefUILookup, sefUIElement, sefUIElementNav metadata database tables with sefUIElementType=‘report’. Reports could have groups defined based on a collection of fields or one field.

Print preview would be supported from dynamically rendered remote client GUI

4) SEF Form/Ul Browser Designer

Form/UI Browser Designer generally designs the GUI for each simple form of tab/folder of a remote client application. Tabs content would generally include simple data bound and none bound controls such as text box, list/combo boxes, lookup buttons, labels, images, check boxes. Data produced by UI Browser Designer may be persisted into sefUIControl, sefUILookup, sefUIElement, sefUIElementNav metadata database tables with sefUIElementType=‘form’.

5) SEF Database Generator

The SEF Database Generator generally builds a business database for a particular SEF Framework deployment, based on data stored in metadata created by the SEF Content Designer, SEF Folder Designer, SEF Report Designer, and the Form/UI Browser Designer. It would generally also automatically add Audit Fields to each table, would build views needed for GUI rendering and non normalized views for reporting. After business database is built, the tool may also configure new database' tables for replication (as replication articles), and apply scripts to build archive triggers dynamically. This tool is generally used when a customer business database is being built and deployed.

6) SEF Remote Client Dynamic Rendering Components

In general, the SEF Remote Client Dynamic Rendering Components build tab interfaces and display data for remote user based on metadata and business databases contents. Upon selecting a tab, for example, a grid pane would present list of all records in a table associated with the tab. The user could select any record in the grid for editing or delete, add a new record, or filter data in the grid using search box and button per any field in a grid. Grids are generally scrollable and sortable by any field.

B. RUNTIME CLIENTS

The SEF factory further includes several runtime clients, such as a SEF Browser™, an SEF Auditor Browser™, SEF EAI™, and SEF B2B™.

1) SEF Browser

The SEF Browser allows user interaction with the back-end-system for data manipulation and reporting. This module generally performs the basic functionality of a common browser once it interprets and presents GUI pages in a dynamic way (aka not hardcode) as folders. Unlike most commercial available browsers, SEF Browser may not be able to be compromised through the use of scripts, examination of underlying code, or replacement of components.

In general, the SEF Browser is a windows application that accesses a MS-SQL database to generate the different folders that will be used in a specific implementation of the framework. Rendering generally happens every time a new session is initiated and when new data is available posted by the central database. After the application starts and when the user is authenticated, control will be passed to the “rendering engine” that will render each form the user has access to. Rendering will also be aware of the user rights to each individual folder component. The “rendering engine” is an out of process service that is called every time the data is changed in the local database and after new user authentication.

For example, an application could have the following folders: Persons, System Files, SIM (smart) Card programming, SIM (smart) card management, Roles and permissions, Reports, and Forms. In general, authentication can be performed by the use of a smart card or any other industry standard authentication protocol. When the application starts up no folders will be available, only a login screen displaying ‘please insert smart card’. When a smart card is inserted the user will enter a password. The password contained in the card will be compared with the password entered by the user. In an embodiment, SEF Browser may have a XP look. The toolbar and folder control will reflect that look, and may support multiple layers (sets) of folders to a maximum of three.

In one or more embodiments, the folder control will only expose up to three layers of tabs at a time. Because each layer can have multiple rows of tabs, this is a screen real estate concern. When the number of layers goes beyond three, only three will be displayed. When the cursor is moved over the tab area all the tabs will become visible. When the cursor leaves the tab area, three layers of tabs maximum will be displayed.

The service will recognize user's privilege level, passed from the authentication service for each available folder: View, Add, Change, Delete.

User's privilege level will be at the folder level. Recognizes user's privilege level, passed from the authentication service for each available folder: View, Add, Change, and Delete

Uses xml to communicate layout information to the component and constructs only the appropriate screen elements that user is authorized to access

2) SEF Auditor Browser

SEF Auditor Browser is a .NET smart client that will have online access to the SEF Central DB. In general, it has access to all the data, active and non-active, and is used to manually correct improper data. Unlike the SEF Browser that was connected to the locally replicated database, the SEF Auditor Browser is connected directly to the Central Archive database and can only be used online.

C. Metadata

SEF further includes a set of metadata constructs that may be stored in the SEF Master Database: high-level system, security/authentication, entity definition, presentation layer.

High-level system metadata may be stored in the following tables.

sefDBMS—System DBMS specifics

sefModule—Software modules/assemblies required by the system

sefModuleType—Type of module/assembly Determines how the module is handled (XCOPY, install, etc)

sefModulePredecessor—Establishes module/assembly order Used to determine module deployment order

sefsystem—Specific system/application details

sefSystemAuthenticationRequirement—Authentication steps required to gain access to this system. (See related elements in section below)

sefSystemDatabase—Database configuration details Connection string,

sefSystemType—System/application type Such as “Foster”

sefSystemWebServer—WebServer configuration details

Security/Authentication metadata may be stored in the following tables:

sefAuthorizationGroup—Definition of groups of users that share permissions

sefAuthorizationGroupModule—Modules that are distributed to an authorization group

sefAuthorizationGroupAttribute—Definition of attribute/column permissions for authorization groups Defines vertical filtering for an authorization group

sefAuthorizationGroupEntity—Definition of entity permissions for authorization groups

sefAuthorizationGroupFilter—Association of data filters with authorization groups Filters are used for horizontal filtering

sefAuthorizationGroupType—Authorization group type Such as “Organization” and “Role”

sefAuthenticationType—Definition of types of supported system authentication SmartCard (separate type for each API), Biometrics, User login

sefEntityFilter—Association between an entity and a filter

sefFilterAttribute—Attributes/columns that are part of the filter definition

sefFilterAttributeGroup—Association between attributes/columns and filter groups

sefFilterGroup—Grouping of attributes/columns for filtering and whether an AND or OR should be applied

sefUser—System/application user details

sefUserAttribute—Definition of user permissions to attributes/columns Defines vertical filtering for users

sefUserAuthorizationGroup—Association of users to authorization groups. Used to define roles and organizations or any other authorization groups that a user belongs to

sefUserEntity—Definition of user permissions to entities

sefUserFilter—Association of data filters with users Filters are used for horizontal filtering

sefUserSmartcard—Association of smart card data with specific user

Entity definition metadata may be stored in the following tables:

sefAttributeValidation—Validation rules that are applied to specific attributes/columns

sefDataType—Datatypes and type mappings from NET to SQL

sefEntity—Entity definitions Used to create tables and business objects

sefEntityAttribute—Attributes/columns of entities

sefRelationship—Relationships between entities

sefRelationshipType—Type of relationship One-to-many/parent child, one-to-many/lookup, many-to-many

sefTransferRequirement—Definition of transfer rules/prerequisites for specific entities

sefValidationType—Types of validation Determines the type of validation controls that are used in the UI

Presentation layer metadata may be stored in the following tables:

sefFolder—Definition of presentation folder

sefFolderParent—Definition of folder hierarchy

sefUIAttribute—Details of UI display of attribute/column

sefUIChild—Definition of child record display in UI

sefUIControl—Definition of control for UI

sefUIControlAttribute—Association of UI control with attribute/column

sefUIControlFont—Font definition for control

sefUIControlProperty—Property definitions for control

sefUIControlType—Control type and type mapping for ASP.NET, WinForms and Reports

sefUIElement—Definition of UI Element Used to define standard UI, reports and forms

sefUIElementFolder—Association of UI Element with folder

sefUIElementType—Type of UI Element Standard UI, Report or Form

sefUILookup—Definition of lookup form used in conjunction with UI Element

sefUIProperty—List of discreet UI properties with property name mappings for ASP.NET, WinForms, and Reports

sefUISelect—Definition of presentation of list/selection controls in the UI

sefUISelectCaption—Definition of displayed items in a list/selection control

In addition, several database methods are also associated with the metadata:

sefEntityMethod—Association of entities with methods

sefEntityMethodParam—List of parameters for specific entity methods

sefMethod—System/application methods

sefMethodParam—Definition of parameters that are required for specific methods

sefUIControlMethod—Association of UI controls with methods

sefUIControlMethodParam—List of parameters for specific UI control methods

D. Deployment Databases

Once created, the following databases are generally created: SEF Master Database, SEF Central Database, and SEF Remote Database.

1) SEF Master Database

In general, the SEF Master Database stores information about all of the systems that have been designed and deployed with the SEF (“deployed systems”). The SEF Central Database generally stores all application's data in the following sections:

Folder and Report—Contains the XSD and XSLT definitions. The repository will allow version control

Application's Data—This is the part of the application that will be specific to each deployment. The SQL artifacts will be created by the Content Designer.

Folder Migrations—Used to archive data that no longer is being used by the application. This can occur every time a column is dropped from on the of the application folders.

Users—Contains all the user information

Folder Security—Contains the definitions of every role.

Archive—

System Configuration—Contains all system configurations which include

In general, each user role will have the following privileges: Update, View, Delete, Add, and Batch update. Deletion of record will happen by marking a record with the deleted flag. Physical deletion will generally never occur.

The database will have several jobs which include: archiving. That is, non-current versions of all records in the database will be copied to the Central Archive DB using triggers and stored procedures. Non-current versions of records will not be replicated to the Remote DB instances.

2) SEF Central Database

As previously described, SEF Central Database is generally the central repository of the actual application data. There is usually a single SEF Central DB per deployment.

3) SEF Remote Database

The SEF Remote Databaser™ allows remote users to work offline and stores all application's data in the following sections. In general, the SEF Remote DB will use MS-SQL Server 2005 Express. The SEF Central Database will be replicated to an SEF Remote Database whenever the remote computer becomes online. Each SEF Remote Database will be replicated to the SEF Central Database whenever the remote computer becomes online. The other SEF updates will then be replicated from the SEF Central Database

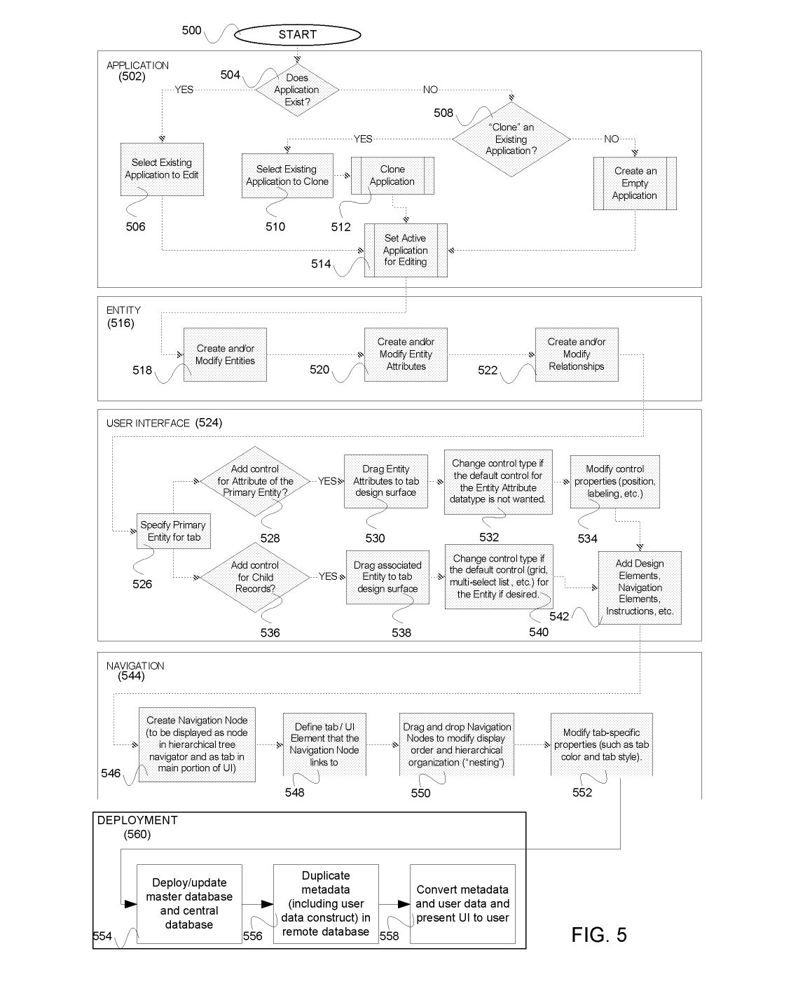

Referring now to FIG. 5, simplified diagram showing the process of creating or updating an enterprise application with the SEF, according to one or more embodiments of the invention. The process may be divided into five phases: an application design phase 502, an entity design phase 516, a user interface design phase 524, a navigation design phase 544, and a deployment phase 560. The first four phases may be considered a design-development phase. In general, during the application 502 and entity 516 phases, a SEF Folder Designer is principally used, whereas during the User Interface 524 and Navigation 544 phases, a SEF Content Designer is principally used.

Initially, during the application design phase 502, at step 504, a business analyst determines if the application already exists. If so, then an existing application is chosen at 506. If not, the business analyst determines if an existing application should be cloned at 508. If not, an empty application is created at 516. If so, an existing application to be cloned is selected at 510, after which the application is cloned at 512. Next, regardless of whether the application existed, created, or cloned, the application is set active for editing at 514, at which point it enters the entity design phase 516.

During the entity design phase 516, initially at 518, entities are created or modified. Next attributes are created or modified at 520. Finally relationships are created or modified at 522, at which point it enters the user interface development phase 524.

During the user interface design phase 524, initially at 526, a primary entity for tab is selected. If a control for attribute of primary entity is required at 528, entity attributes to tab design surface is dragged at 530. Next, if required, the control type is changed if the default control for the entity attribute data type is not wanted at 532. Next, if required, control properties (e.g., position, labeling, etc.) are modified at 534. Next, design elements, navigation elements, instructions, etc. are added at 542. If a control needs to be added for child records at 536, the associated entity is dragged to tab design surface. Next, if required, the control type is changed if the default control (e.g., grid, multi-select list, etc.) at 540. Next, as before, design elements, navigation elements, instructions, etc. are added at 542.

During the navigation design phase, a navigational node is created at 546. A navigational node is generally displayed as a node in hierarchical tree navigator and a s tab in main portion of user interface. Next, a tab/UI element is defined at the navigation node to which to link, at 548. Next, navigation nodes are dragged and dropped to modify display order and hierarchical organization (“nesting”), at 550. Finally, tab-specific properties (such as tab color and tab style) are modified.

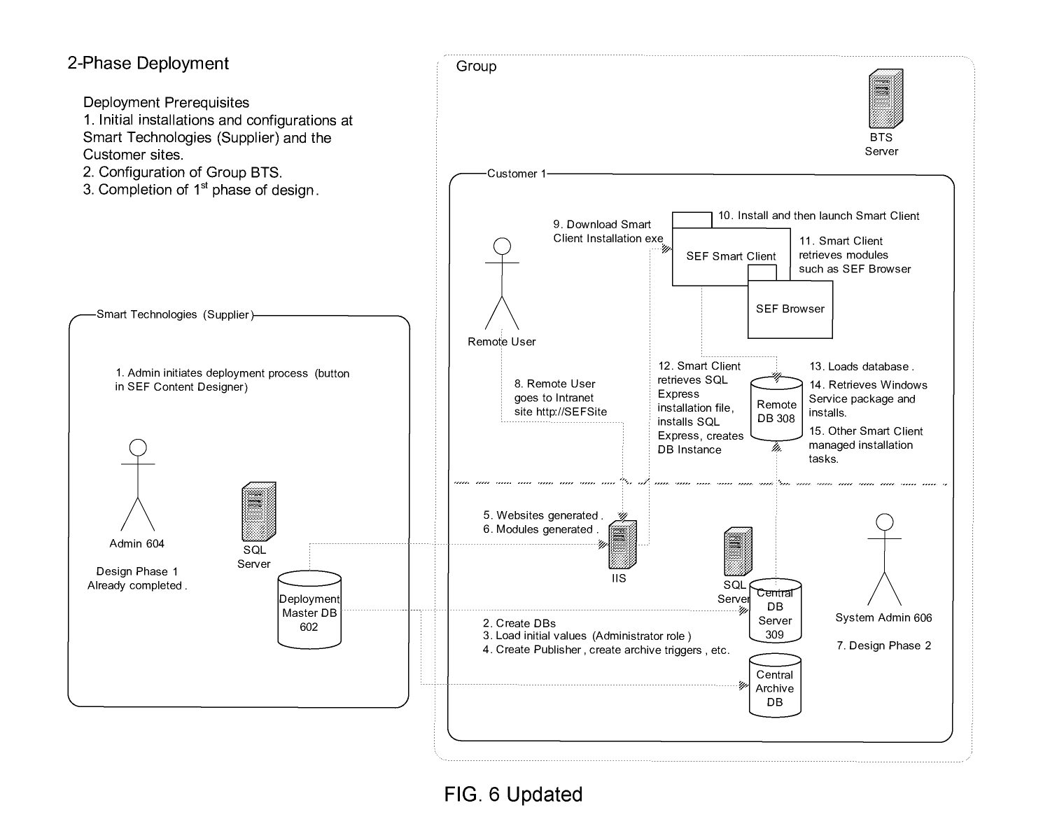

One or more of the above steps may not be performed in updating but not creating an application. Metadata (including user data construct/structure) created during one or more of application design phase 502, entity design phase may be stored in a deployment master database (e.g., deployment master database 602 shown in the example of FIG. 6).

During the deployment phase, at 554, the metadata are deployed/updated in a central database server (e.g., central database server 309 shown in the example of FIG. 4 and 6). The metadata may be stored in a master database (e.g., master database 319 shown in the example of FIG. 4) and may cause update of user data stored in a central database (e.g., central database 329 shown in the example of FIG. 4).

At 556, the metadata may be replicated/updated in one or more remote databases (e.g., remote database 308 shown in FIG. 4) in one or more client devices.

At 558, logic in the one or more client devices may convert the metadata and relevant user data to present useful user interface and information to one or more users for user interaction. When the application is run, a user is authenticated, and the application is presented according to the user's permissions. UI metadata and navigation metadata (from predefined tables) are used to construct the application with folders (or tabs) and controls that are available according to the user's permissions.

Updating the application may become simple and transparent. Because data are synchronized between the central database server (e.g., central database server 309 shown in the example of FIG. 6) and the remote database (e.g., remote database 308 shown in the example of FIG. 6) in a remote client by replication and there is a copy of the deployed databases on the deployment master database (e.g., deployment master database 602 shown in the example of FIG. 6), updating may become a matter of making changes to the copy and then updating the database on the central database server. In one or more embodiments, only metadata changes in the master database (e.g., master database 319 shown in the example of FIG. 4) and structural changes in the central database (e.g., central database 329 shown in the example of FIG. 4) may be made, since no copy of actual user data is kept on the master server. Once the database on the central server has been changed, then replication to the client may facilitate transparent changes to the application. Advantageously, in accordance with one or more embodiments of the present invention, there is no need for modifying code, compiling code, and then upgrading an application as typically required by legacy applications and even smart client applications.

Referring now to FIG. 6, a simplified diagram of a SEF deployment is shown, according to one or more embodiments of the invention. Initially at 1, an administrator 604 (admin 604) may initiate a deployment process. Admin 604 may create one or more of the following metadata in a deployment master database 602: entity and relationship metadata, UI (user interface) metadata, navigation metadata, etc. Alternatively or additionally, one or more of the above metadata also may be created with different hardware and/or software, and then be transferred to deployment master database 602. The entity and relationship metadata may used by a system deployment tool to create user database structure in preparation for deployment to central database server 309. The entity metadata may produce tables, and the relationship metadata may become foreign key-primary key relationships in user database stored in central database server 309. When the metadata are completely prepared on deployment master server 602, the metadata are ready to be deployed to central database server 309.

Next at 2, two databases (i.e. a master database for storing metadata and a central database for storing application/business/user data) are created/deployed in central database server 309. Next at 3, initial values may be loaded by system administrator 606. At 4, a publisher application may be created, along with archive triggers, etc. At 5, websites may be generated. At 6, modules may be generated. At 7, the design phase may begin. At 8, a remote user may access an intranet site for subsequent operations. At 9, a smart client is downloaded. At 10, a smart client may be installed then launched. Next at 11, the smart client may retrieve modules, such as the SEF browser. At 12, smart client may retrieve MSDE installation file, install MSDE, and create DB instance. At 13, remote database 308 may be loaded with new or updated data. Metadata stored in central database server 309 may be replicated in remote database 308. At 14, the Windows service package may be retrieved and installed. And finally at 15, other smart client managed installation tasks may be performed.

With traditional three or even n-tier applications, changing data requirements typically require modifications in several tiers. A prior art Smart Client application may require changes to some ASP.NET components. In contrast, a SEF system may reduce or eliminate coding requirements by using metadata to configure user experience (e.g., presentation of an application). The SEF system may be completely data driven by providing complete data objects (data, methods, and properties) and business processes described in metadata.

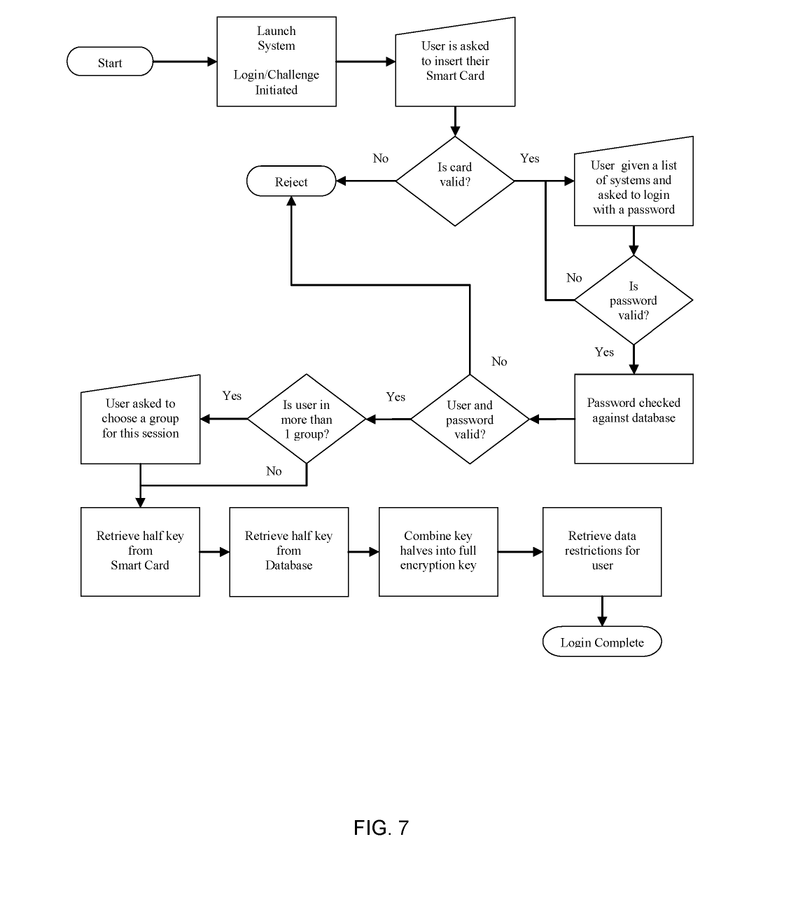

Referring now to FIG. 7, a simplified diagram of SEF authentication is shown, according to one or more embodiments of the invention. In an advantageous manner, the SEF framework maintains a substantially high level of trust. For example, if a server is compromised, a laptop or smartcard stolen, or a password compromised, overall system integrity is maintained.

In general, data stored at the server is encrypted such that if the database where compromised, the intruder would not be able to read the information. In addition, data is generally encrypted or decrypted on client machines when necessary, providing several advantages:

Improved server security—if a server is compromised and an intruder has physical access to a server, data may not be read out of it;

Improved remote security—when a machine has a local copy of data, it is also encrypted, so that even if the machine is lost or stolen (as common with laptops), the data may not be read out of the database; and

Better performance—the database server manages data delivery, and not cryptography.

In general, there are two types of data encryption used in the system: Very secure encryption and fast encryption. Very secure encryption, using the Blowfish algorithm, may be used for all business data. Blowfish is an extremely secure encryption scheme that is relatively resistant to brute force attacks. Fast, less secure encryption is may be used for non-business data necessary to support the system. While this data does not necessarily need to be encrypted to satisfy business requirements, encrypting it helps decrease the chance that someone with physical access to a machine could glean useful information from the system.

In general, one way to attack an encrypted system is to examine the encrypted data to see what can be learned. The Blowfish algorithm already provides an excellent defense against such inspection, but a hacker might be able to notice similarities between different pieces of data in the system. Or, someone with access to some records, might be able to glean information about other records that they do not have permission to access. To prevent these attacks, every single column of data is generally encrypted differently from all other columns. In addition, it is possible to set up a column so that every individual value encrypted differently from all other values, providing near perfect security of the data.

When a system is setup, two encryption keys are generally created for the system and all data stored in the system is encrypted with those keys. Separate keys are created for the Blowfish encryption and the fast encryption, so that a compromise of the Fast encryption does not compromise the Blowfish keys. The encryption keys are random bit strings generating using a cryptographic random number function and are tested for quality using a Blowfish-specific algorithm. In addition, the encryption keys themselves are not stored anywhere. Instead, each encryption key is split in half (using a random algorithm), with half of the key stored in the database and half of the key stored in a Smart Card. The halves are somewhat misnamed because each is actually the same size as the key. When examined independently, each half of the key provides no information about the other half of the key or the key itself.

The actual encryption key is generally only available when a Smart Card is provided along with access to the system and the two halves of the key are combined into the actual key. The actual key is only available in memory and is never written out to disk or transmitted over a network connection. The encryption key may be split independently for each Smart Card. The way this actually works is that an administrator Smart Card must be provided in order to provision a new user. This allows the system to obtain the actual key in memory. When the new Smart Card is written, the key is split in half randomly, which results in two halves which have no relationship to the halves used for any other key. Again, one of these halves is stored in the database and one of the halves is stored in the Smart Card.

A single Smart Card can provide access to multiple systems. When the user inserts the Smart Card, they will be presented with a list of all systems and can login to any one of them. They may have a separate password for each system and the Smart Card contains a one-way MD5 hash that is used to verify that the user has the correct password for the specified system. The Smart Card can also allow for a separate card PIN which is the same for all systems. Although the password is checked by the Smart Card, it is checked again in the database. This also uses a one-way MD5 hash, but it uses different data to prevent any attack here.

Should a hacker manage to bypass the password checks (for example, using a hardware debugger to circumvent application security), he would not generally have the proper decryption key, since the key on the Smart Card is encrypted with the password that would have to be circumvented. Without the proper key, they cannot decrypt data out of the database, even if they can read it.

In addition, a user can be a member of multiple user groups, each of which has different permissions for the database. For example, an administrator may also be a member of a user group. If the user is a member of more than one group, they will be asked which group they want to use for this session after they have successfully authenticated.

Each user group and possibly each user have a set of data access restrictions assigned to them. These restrictions are read from the database after login is complete and stored in memory. In addition, each form may have specific restrictions assigned to it. These restrictions are combined in every database query to prevent users from seeing data that they do not have authority to access.

The application itself is generally secured using Microsoft's NET security and signing. Each component within the system will be signed as being part of the same system, using a signing key that is only known by Smart Technologies Group. Each component will be marked as only trusting other signed components, which prevents hackers from either modifying or inspecting running code in the system.

In addition, after login is complete, the local machine knows where to reach the server and can begin downloading and/or updating local data from the server. Once a given server system has been used by a given local machine, the local machine can continue to get updates to the server, given a certain level of Windows domain security and network security.

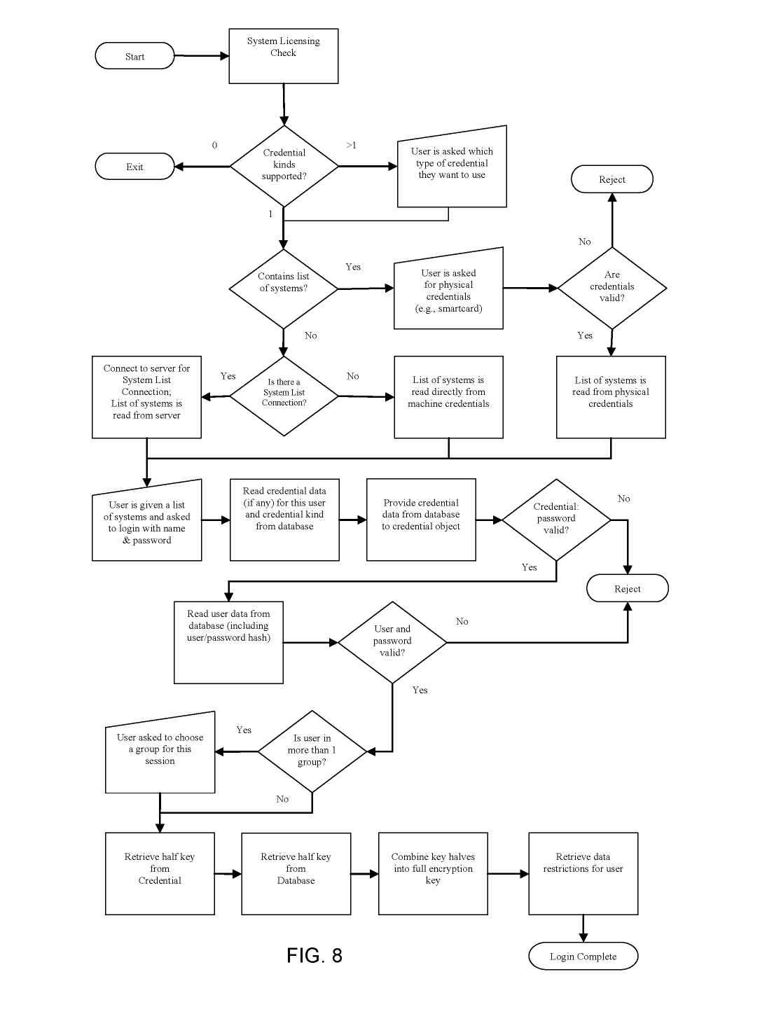

FIG. 8 illustrates a simplified diagram of a SEF authentication process, according to one or more embodiments of the present invention. Each group of users may be given permissions for or authorization to specific data. The permissions associated with the users may be stored as application data in a EFS Central Database and replicated in a EFS Remote Database. When a user is authenticated, the application may be configured using the group's permissions to restrict to a specific set of data.

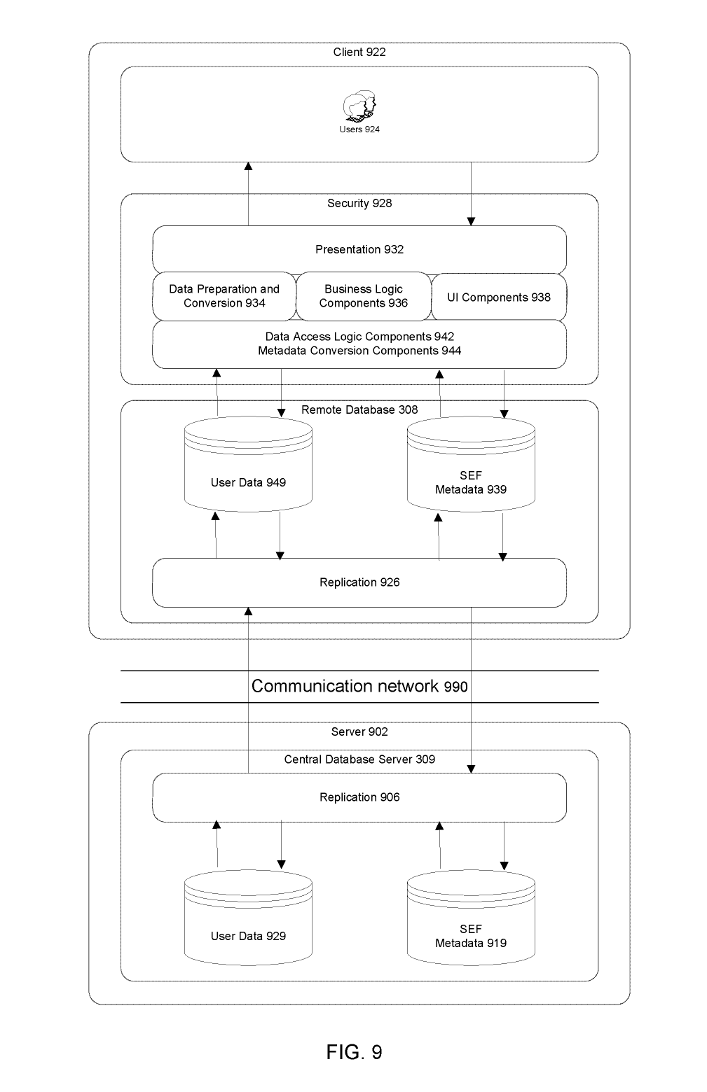

FIG. 9 illustrates a simplified block diagram of a deployed SEF system (a client-server system) according to one or more embodiments of the invention. The client-server system (the system) may be deployed using the steps described with reference to FIG. 6. The system may include a client 922 for executing an application and a server 902 for providing metadata for constructing and supporting the application. Client 922 and server 902 may be connected through communication network 990, which may include one or more of the Internet and a wireless network.

Server 902 may include central database server 309 for storing metadata 919 and user data 929. Metadata 919 may be configured to support assembling the application and to coordinate data with control(s) of the application. User data 929 may include data entered by one or more users of the system such as, for example, user names.

Client 922 may include remote database 308 for storing metadata 939 and user data 949. Metadata 939 may include data replicated from metadata 919. User data 949 may include data entered or generated during use of the application as well as user data structure/construct replicated from user data 929. Data in user data 949 also may be replicated and included in user data 929. Replication may be performed by one or more of replication logic 906 and 926 included in one or more of server 902 and client 922.

Client 922 may include presentation logic for converting/rendering metadata and relevant (decrypted) user data to present useful user interface and information to one or more users for user interaction. Client 922 may store user authentication and authorization information pertaining to the one or more users. Client 922 may include security module for performing user authentication and authorization. Client 922 may include data preparation and conversion module 934 for decrypting data from user data 949. Client 922 may include business logic components that define property and methods for processing data from one or more or user data 949 and metadata 939. Client 922 may include UI components, which include controls displaying and entering user data. Client 922 may include data access logic components 942 for providing methods to process, primarily decrypt, data from user data 949. Client 922 may include metadata conversion components for providing methods to decrypt and utilize metadata from metadata 939 to build entry screens and to coordinate the metadata with appropriate control(s).

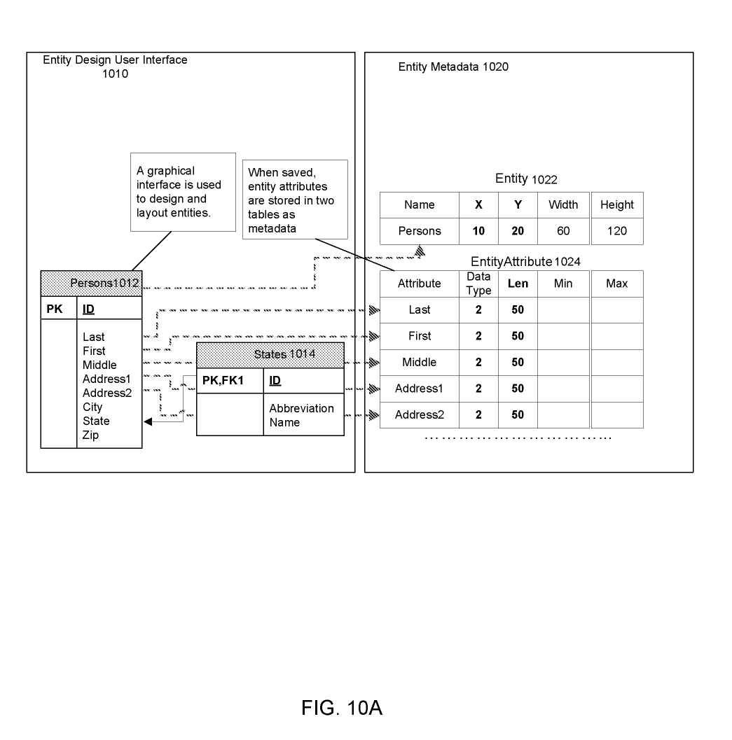

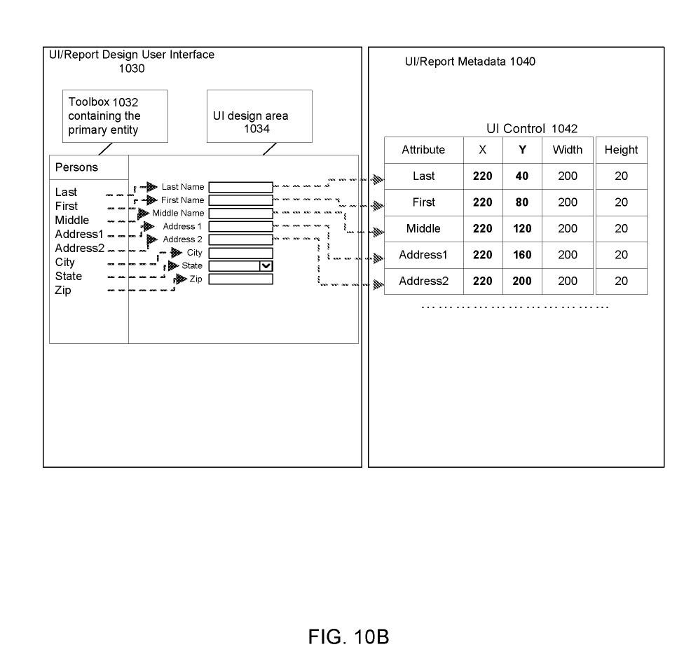

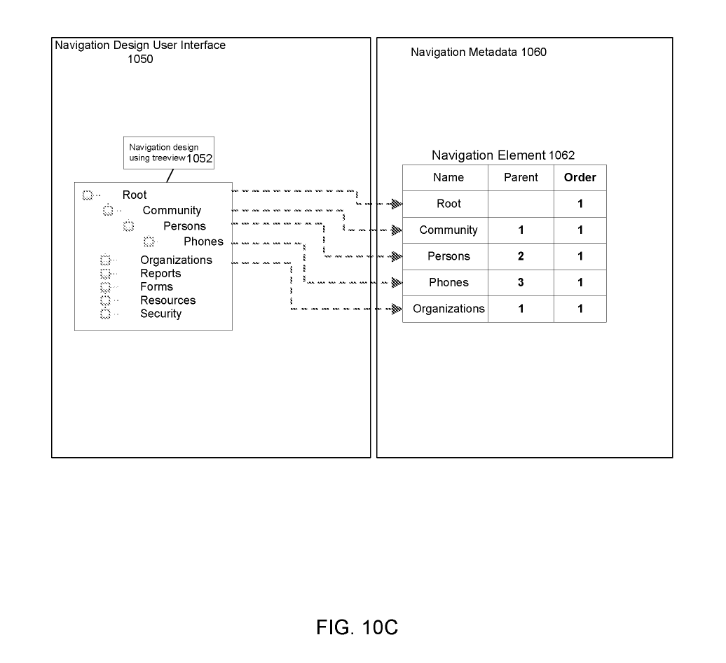

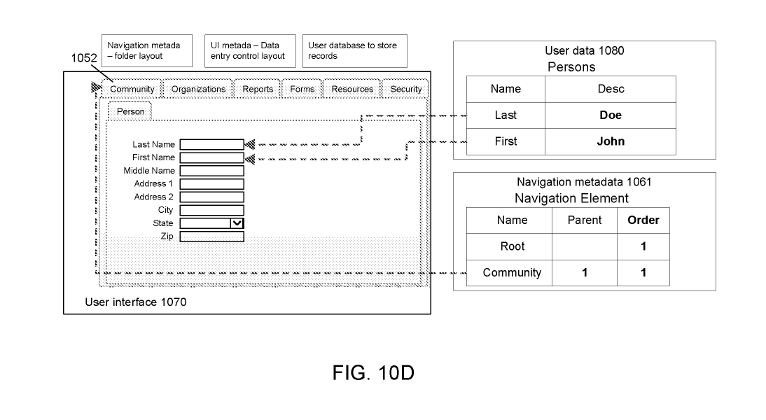

FIGS. 10A-D illustrate example user interfaces and associated metadata according to one or more embodiments of the invention and corresponding to an entity design phase, a user interface design phase, a navigation design phase, and a deployment phase, respectively, such as entity design phase 516, user interface design phase 524, navigation design phase 544, and deployment phase 560 shown in the example of FIG. 5.

FIG. 10A illustrates entity design user interface 1010 and entity metadata 1020. In entity design user interface 1010, entities (such as persons 1012) may be created on a graphical design area, and then attributes (such as states 1014) may be added with a right mouse click. Entity metadata 1020 pertaining to attributes of the entity design may be constantly updated in tables (such as entity table 1022 and entity attribute table 1024) in a master database (such as master database 319 shown in the example of FIG. 4) and may be replicated in a remote database (such as remote database 308 shown in the example of FIG. 4) in a client device (such as client 922 shown in the example of FIG. 9).

FIG. 10B illustrates UI/Report design user interface 1030 and UI/Report metadata 1040. UI/report design may be driven by entity-component mapping. A UI/report designer may interpret metadata that describe entity attributes. Accordingly, toolbox 1032 may show a primary entity related to a folder and all attributes (correlating to table columns) of the primary entity. In addition, related entities may be displayed. Dragging these attributes and/or related entities to UI design area 1034 may result in a default UI control being rendered based on data type(s) of the attributes and/or relationship type(s) of the related entities. UI/report metadata 1040 pertaining to the default UI control may be stored and constantly updated in UI Control table 1042 in a master database and may be replicated in a remote database in a client device.

FIG. 10C illustrates navigation design user interface 1050 and navigation metadata 1060. Navigation design may begin with developing a hierarchical structure of elements indented as appropriate in a treeview control, such as treeview 1052. As elements may be added to treeview 1052 in a vertical manner, the elements may ultimately be displayed horizontally or vertically as folders with a tab for each folder. Caption for the tab may be the text entered for an element associated with the folder/tab in treeview 1052. Navigation metadata 1060 pertaining to the elements may be stored and constantly updated in navigation element table 1062 in a master database and may be replicated in a remote database in a client device.

FIG. 10D illustrates user interface 1070, navigation metadata 1061, and user data 1080. As discussed above, metadata including entity metadata 1020, UI/report metadata 1040, and navigation metadata 1060, such as navigation metadata 1061, may be stored in the master database and replicated in the remote database in the client device. Logic in the client device may convert/interpret the metadata to present user interface 1070. Entity metadata 1020 may be used to create a user database and to establish relationships for user interface 1070. UI metadata 1040 may be used to ‘build’ and layout data entry controls for user interface 1070. Navigation metadata 1060 is used to ‘build’, group, and layout folders for user interface 1070. For example, navigation metadata 1061 may be converted and presented as tab 1052. User data such as user data 1080 may then be entered through user interface 1070, stored in a remote database (such as remote database 308 shown in the example of FIG. 4), and replicated in a central database (such as central database 329 shown in the example of FIG. 4). An application designed, developed, and deployed in accordance with one or more embodiments of the present invention may have all the advantages of a desktop application because the application may maintain a local copy of a whole database, but not just a portion of the database. Further, the application may be conveniently tailored according to permissions for specific users by using metadata to “build” data entry screens. Still further, the application may be updated asynchronously and seamlessly without code changes, recompiling, and updating binaries.

As can be further appreciated from the foregoing, embodiments of the present invention may effectively combine data and application layers, thereby advantageously simplifying system management and reducing overall application latency. Embodiments of the present invention also may provide complete and up-to-date data at client devices such that the client devices may have full, updated functions of applications without keeping connected with a server. Further, embodiments of the present invention may update applications by updating and providing metadata, without going through lengthy coding, compiling/recompiling, and/or debugging processes. Further, embodiments of the present invention may proactively and simultaneously update multiple applications on multiple client devices without requiring each client device to individually download and execute individual update programs for individual applications.

While this invention has been described in terms of several preferred embodiments, there are alterations, permutations, and equivalents which fall within the scope of this invention. Advantages of the invention include an architecture for a smart enterprise framework and methods thereof Additional advantages include availability, security, scalability, reusability, manageability, interoperability, extensibility, performance, and an audit trail.

It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alternations, permutations, and equivalents as fall within the true spirit and scope of the present invention.

What is claimed is:

1. A system for enabling a user to execute an application on a client device, the system comprising:
a first datastore configured to store metadata pertaining to at least one of design, development, deployment, presentation, and execution of the application, the at least one of design, development, deployment, presentation, and execution of the application pertaining to at least one of user interface and business logic of the application;
a second datastore configured to store application data pertaining to utilization of the application;
a third datastore residing in the client device and configured to store replicated metadata and replicated application data, the replicated metadata being a copy of the metadata, the replicated application data being a copy of the application data; and
logic residing in the client device and configured to convert at least the replicated metadata into the at least one of user interface and business logic of the application.

2. The system of claim 1 wherein the at least one of user interface and business logic of the application is the business logic of the application.

3. The system of claim 1 wherein the logic is configured to convert the replicated metadata and the replicated application data into the at least one of user interface and business logic of the application.

4. The system of claim 1 further comprising a development client configured to perform the at least one of design, development, deployment, presentation, and execution of the application using the metadata.

5. The system of claim 1 further comprising a development client configured to create metadata constructs according to requirements of at least one of the user and a customer of the system, the metadata constructs pertaining to the at least one of design, development, deployment, presentation, and execution of the application and being stored in the first datastore.

6. The system of claim 1 wherein the metadata includes data pertaining to at least one of the system, security for the application, authentication for the user, entity definition for at least one of the user and the application, and presentation layer for the application.

7. The system of claim 1 further comprising second logic configured to replicate the metadata into the replicated metadata when the metadata is changed without requiring manual user involvement for each change of the metadata.

8. The system of claim 1 further comprising second logic configured to replicate, without a request of the user, the metadata into the replicated metadata whenever the client device is connected with the first datastore.

9. The system of claim 1 wherein the logic is configured to convert the at least the replicated metadata into the at least one of user interface and business logic of the application whenever the client is connected with the first datastore.

10. The system of claim 1 wherein the at least one of user interface and business logic of the application includes at least one of a navigation function and an authentication function.

11. A method for deploying an application on a client device used by a user, the method comprising:
creating a first datastore for storing metadata pertaining to at least one of design, development, deployment, presentation, and execution of the application, the at least one of design, development, deployment, presentation, and execution of the application pertaining to at least one of user interface and business logic of the application;
creating a second datastore for storing application data pertaining to utilization of the application;
creating a third datastore in the client device for to storing replicated metadata and replicated application data, the replicated metadata being a copy of the metadata, the replicated application data being a copy of the application data; and
implementing logic in the client device for converting at least the replicated metadata into the at least one of user interface and business logic of the application.

12. The system of claim 11 wherein the at least one of user interface and business logic of the application is business logic of the application.

13. The method of claim 11 further comprising:
cloning an existing application, using existing metadata pertaining to the existing application and without coding, to produce an active application; and
editing the active application to create the application.

14. The method of claim 11 further comprising:
creating an empty application, using the metadata and without coding, to produce an active application; and
editing the active application to create the application.

15. The method of claim 11 further comprising replicating the metadata into the replicated metadata when the metadata is changed without requiring manual user involvement for each change of the metadata.

16. The method of claim 11 further comprising replicating, without a request of the user, the metadata into the replicated metadata whenever the client device is connected to the first datastore.

17. The method of claim 11 further comprising converting, without a request of the user, the at least the replicated metadata into the at least one of user interface and business logic of the application whenever the client device is connected to the first datastore.

18. A method for updating an application on a client device used by a user, the method comprising:
connecting the client device to a first datastore, the first datastore storing metadata pertaining to at least one of design, development, deployment, presentation, and execution of the application, the at least one of design, development, deployment, presentation, and execution of the application pertaining to at least one of user interface and business logic of the application;
replicating the metadata to produce replicated metadata; and
converting at least the replicated metadata into the at least one of user interface and business logic of the application.

19. The method of claim 18 wherein the at least one of user interface and business logic of the application is business logic of the application.

20. The method of claim 18 further comprising storing the replicated metadata in the client device.

21. The method of claim 18 further comprising connecting the client device to a second datastore, the second datastore storing application data pertaining to utilization of the application.

22. The method of claim 21 wherein the converting includes converting the replicated metadata and the application data into the at least one of user interface and business logic of the application.

23. The method of claim 21 further comprising replicating the application data to produce replicated application data.

24. The method of claim 23 wherein the converting includes converting the replicated metadata and the replicated application data into the at least one of user interface and business logic of the application.

25. The method of claim 18 wherein the replicating is performed without a request of the user.

26. The method of claim 18 wherein the converting is performed without a request of the user.

27. The method of claim 18 further comprising simultaneously updating the application on a second client device used by a second user without requiring an explicit manual involvement by the second user.

28. The method of claim 18 wherein the at least one of user interface and business logic of the application includes at least one of a navigation function and an authentication function.
